(19) United States
(12) Patent Application Publication
(10) Pub. No.: US 2026/0099541 A1
(43) Pub. Date: Apr. 9, 2026

(54) DETERMINING AND TAGGING LANGUAGES IN AUDIO FILES

(71) Applicants: Sony Group Corporation, Tokyo (JP); Sony Pictures Entertainment Inc., Culver City, CA (US)

(72) Inventors: Justin Arnold Herman, Los Angeles, CA (US); Benjamin Coflan, Los Angeles, CA (US)

(21) Appl. No.: 18/908,538

(22) Filed: Oct. 7, 2024

(51) Int. Cl. G06F 16/65; G06F 16/68; G10L 15/00; G10L 15/06; G10L 25/57; G10L 25/78; G11B 27/34

(52) U.S. Cl. CPC G06F 16/65; G06F 16/686; G10L 15/005; G10L 15/063; G10L 25/57; G10L 25/78; G11B 27/34

(57) ABSTRACT

Automatically detecting, tagging, and removing a human language stored in an audio file, including: training an application for detecting the human language using machine learning; loading each channel of the audio file into the trained application, wherein the audio file is an audio deliverable for motion picture and television; setting parameters and filtering each channel of the audio file to detect and tag the human language; and generating a list of timecodes and the corresponding human language detected.

### BACKGROUND

### Field

The present disclosure relates to determining and tagging languages in audio files, and more specifically to training an application to detect the human language using machine learning and loading each channel of the audio file into the trained application.

### Background

Determining and tagging languages in audio files may be an important task for a Music and Effects Quality Control checker, who provides an audio deliverable for all motion picture and television. However, in cases where the audio files lack metadata, providing an audio deliverable with languages determined, tagged, and removed (if desired) involves many laborious hours of systematically going through the audio files listening, tagging, and/or removing by a human operator.

Accordingly, there is a need for automatically determining, tagging, and removing language(s) stored in the audio files.

### SUMMARY

The present disclosure provides for determining and tagging languages in audio files.

In one implementation, a method for automatically detecting, tagging, and removing a human language stored in an audio file is disclosed. The method includes: training an application for detecting the human language using machine learning; loading each channel of the audio file into the trained application, wherein the audio file is an audio deliverable for motion picture and television; setting parameters and filtering each channel of the audio file to detect and tag the human language; and generating a list of timecodes and the corresponding human language detected.

In another implementation, a system for automatically detecting, tagging, and removing a human language stored in an audio file is disclosed. The system includes: an application for detecting the human language; a machine learning logic to train the application, wherein the trained application receives and loads each channel of the audio file, which is an audio deliverable for motion picture and television; and a filter to set parameters and filter each channel of the audio file to detect and tag the human language, and to generate a list of timecodes and the corresponding human language detected.

In another implementation, a non-transitory computer-readable storage medium storing a computer program to automatically detect, tag, and remove a human language stored in an audio file is disclosed. The computer program includes executable instructions that cause a computer to: train an application for detecting the human language using machine learning; load each channel of the audio file into the trained application, wherein the audio file is an audio deliverable for motion picture and television; set parameters and filter each channel of the audio file to detect and tag the human language; and generate a list of timecodes and the corresponding human language detected.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram illustrating a method for automatically determining, tagging, and/or removing language(s) stored in audio files in accordance with one implementation of the present disclosure;

FIG. 2 is a block diagram illustrating a system for automatically detecting, tagging, and/or removing language(s) stored in audio files in accordance with one implementation of the present disclosure;

FIG. 3A is a representation of a computer system and a user in accordance with an implementation of the present disclosure; and

FIG. 3B is a functional block diagram illustrating the computer system hosting the language tagging application in accordance with an implementation of the present disclosure.

### DETAILED DESCRIPTION

As described above, providing the audio deliverable with languages determined, tagged, and removed, if desired, involves many hours of systematically going through the audio files listening, tagging, and/or removing by a human operator.

Certain implementations of the present disclosure provide for automatically determining, tagging, and/or removing language(s) stored in the audio files. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, an application for detecting human languages is trained using machine learning. Once the application has been trained, it is then used to process, including to determine, tag, and/or remove, language(s) stored in an audio file. In one implementation, the processing includes loading each channel of the audio file into the application. The processing may also include setting parameters and filtering each channel of the audio file. The processing may further include generating a list of timecodes and corresponding language(s) detected.

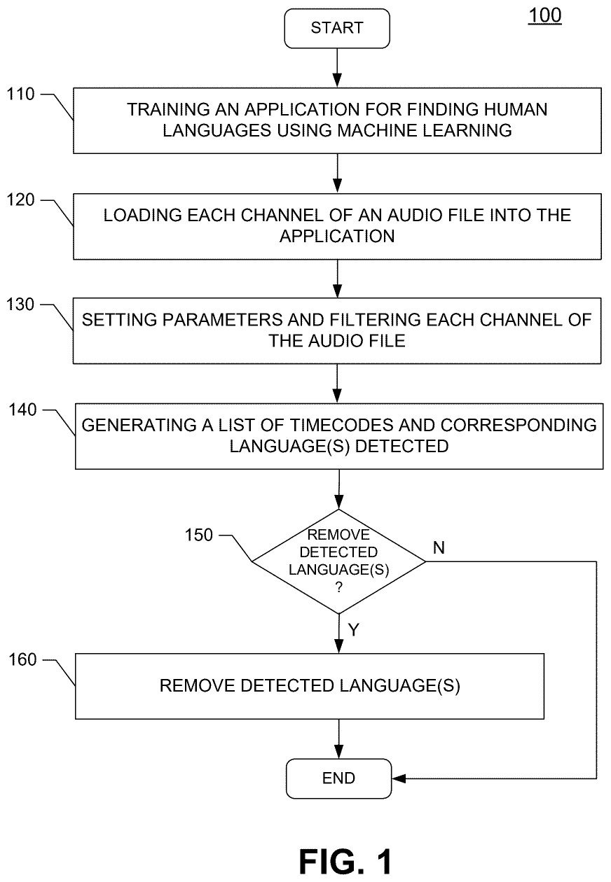

FIG. 1 is a flow diagram illustrating a method 100 for automatically determining, tagging, and/or removing language(s) stored in audio files in accordance with one implementation of the present disclosure. In the illustrated implementation of FIG. 1, the method 100 includes training an application for detecting human languages, at step 110, using machine learning. In one implementation, the application for detecting human languages includes natural language processing. In another implementation, the application for detecting human languages includes speech recognition. In one implementation, the machine learning includes at least one of applying neural network, mathematical optimization, and artificial intelligence. In another implementation, the machine learning includes exploratory data analysis using unsupervised learning.

In the illustrated implementation of FIG. 1, once the application has been trained, at step 110, the method 100 continues with processing of language(s) stored in an audio file, including at least one of determining, tagging, and removing the language(s). In one implementation, the audio file is an audio deliverable for all motion picture and television.

In one implementation, the processing includes loading each channel of the audio file into the application, at step 120. The processing may also include setting parameters and filtering each channel of the audio file, at step 130. In one implementation, setting parameters includes setting a primary language to be determined or detected. In another implementation, filtering each channel includes determining the number of channels in the audio file and determining or detecting the primary language in all channels of the audio file. The processing may further include generating, at step 140, a list of timecodes and corresponding language(s) detected. In one implementation, generating the list of timecodes includes tagging start and end times of the detected language(s) (e.g., a primary language).

In the illustrated implementation of FIG. 1, the method 100 continues with determining, at step 150, whether the detected language(s) should be removed. If the detected language(s) is to be removed, the detected language(s) is removed, at step 160. In one implementation, the removal of the detected language(s) is performed using the list of timecodes. For example, detected primary language is removed starting at the start time and ending at the end time. This process may be repeated until the end of the timecodes in the list and the result may be delivered in the audio deliverable. In one implementation, the audio deliverable includes metadata with the list of timecodes incorporated into it. In one implementation, the metadata also includes the detected language (e.g., English) and a title of the movie to which the audio file belongs. In another implementation, the metadata further includes human-readable text of the detected language(s). In yet another implementation, the metadata further includes an attached text document including the human-readable text of the detected language(s).

In one implementation, the removal of the detected language(s) (at step 160) includes removing only the specified primary language. In another implementation, the removal of the detected language(s) (at step 160) includes removing all human languages detected in the audio file. In yet another implementation, the removal of the detected language(s) is used for replacing the detected language(s) with another language, for example, for an audio dubbing process. In an alternative implementation, the removal of the detected language(s) (at step 160) includes removing only the human language(s) but leaving in or not removing non-language sounds, such as grunts and lip smacks.

In one implementation, the application is built as a plugin that resides on a track of a Digital Audio Workstation (DAW). In this implementation, the detection of the language(s) is flagged natively in the DAW as markers in the timeline.

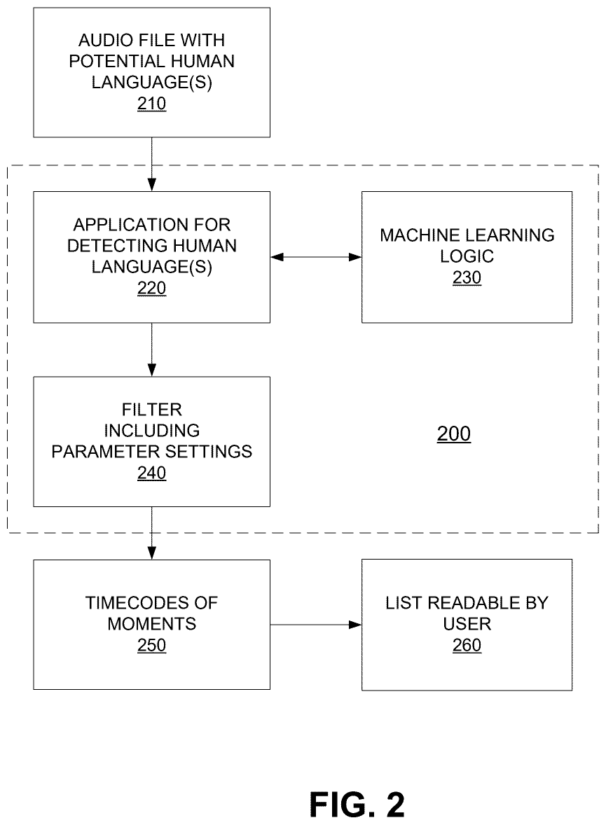

FIG. 2 is a block diagram illustrating a system 200 for automatically detecting, tagging, and/or removing language(s) stored in audio files in accordance with one implementation of the present disclosure. In the illustrated implementation of FIG. 2, the system 200 includes an application 220 for detecting human languages, machine learning logic 230, and a filter 240.

In one implementation, the machine learning logic 230 trains the application 220. In one implementation, the application 220 for detecting human languages includes a natural language processor. In another implementation, the application 220 for detecting human languages includes speech recognition logic. In one implementation, the machine learning logic 230 includes at least one of neural network, mathematical optimizer, and artificial intelligence. In another implementation, the machine learning logic 230 includes an exploratory data analyzer which uses unsupervised learning.

In the illustrated implementation of FIG. 2, the trained application 220 receives an audio file 210 with potential human language(s) stored in it. In one implementation, once the application 220 receives the audio file 210, each channel of the audio file 210 is loaded into the application 220 and processed using the filter 240. Thus, processing of each channel may include setting parameters and filtering each channel of the audio file 210 using the filter 240. In one implementation, the parameters include a primary language to be determined or detected. In another implementation, the parameters include the number of channels in the audio file 210 such that the primary language may be detected in all channels of the audio file 210. In one implementation, the processing of each channel by the application 220 includes at least one of determining, tagging, and removing the human language(s) included in the audio file 220. In one implementation, the audio file 210 is an audio deliverable for all motion picture and television.

In the illustrated implementation of FIG. 2, once the filter 240 is applied to the application 220 to process the channels of the audio file 210, the application 220 generates and outputs timecodes of moments 250 which are start and end times of the detected language(s) (e.g., a primary language). In one implementation, the application 220 also generates and outputs a list 260 of timecodes and corresponding language(s) detected.

In one implementation, the parameter settings in the filter 240 include a flag to remove the detected language(s). If the flag is raised, the detected language(s) is removed. In one implementation, the removal of the detected language(s) is performed using the list of timecodes 260. For example, detected primary language is removed starting at the start time and ending at the end time. This process may be repeated until the end of the timecodes 250 in the list 260 and the result may be delivered in the audio deliverable.

In one implementation, the audio deliverable includes metadata with the list 260 of timecodes incorporated into it. In one implementation, the metadata also includes the detected language (e.g., English) and a title of the movie to which the audio file belongs. In another implementation, the metadata further includes human-readable text of the detected language(s). In yet another implementation, the metadata further includes an attached text document including the human-readable text of the detected language(s).

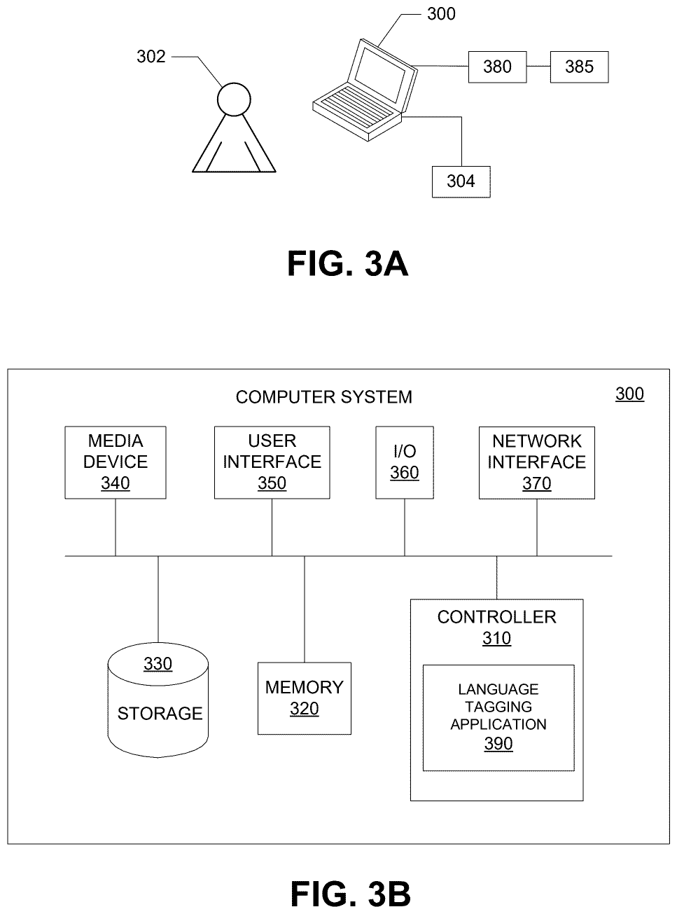

FIG. 3A is a representation of a computer system 300 and a user 302 in accordance with one implementation of the present disclosure. The user 302 uses the computer system 300 to implement an application 390 for detecting and tagging language(s) as illustrated and described with respect to the method 100 illustrated in FIG. 1 and to the system 200 illustrated in FIG. 2.

The computer system 300 stores and executes the language tagging application 390 of FIG. 3B. In addition, the computer system 300 may be in communication with a software program 304. Software program 304 may include the software code for the language tagging application 390. Software program 304 may be loaded on an external medium such as a CD, DVD, or a storage drive, as will be explained further below.

Furthermore, computer system 300 may be connected to a network 380. The network 380 can be connected in various different architectures, for example, client-server architecture, a Peer-to-Peer network architecture, or other type of architectures. For example, network 380 can be in communication with a server 385 that coordinates engines and data used within the language tagging application 390. Also, the network can be different types of networks. For example, the network 380 can be the Internet, a Local Area Network or any variations of Local Area Network, a Wide Area Network, a Metropolitan Area Network, an Intranet or Extranet, or a wireless network.

FIG. 3B is a functional block diagram illustrating the computer system 300 hosting the language tagging application 390 in accordance with an implementation of the present disclosure. A controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the language tagging application 390 with a software system, such as to enable the creation and configuration of engines and data extractors within the language tagging application 390. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data either temporarily or for long periods of time for use by the other components of the computer system 300. For example, storage 330 stores data used by the language tagging application 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

In one implementation, the system 200 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, the system 200 is configured with a combination of hardware and software.

In one particular implementation, a method for automatically detecting, tagging, and removing a human language stored in an audio file is disclosed. The method includes: training an application for detecting the human language using machine learning; loading each channel of the audio file into the trained application, wherein the audio file is an audio deliverable for motion picture and television; setting parameters and filtering each channel of the audio file to detect and tag the human language; and generating a list of timecodes and the corresponding human language detected.

In one implementation, the application for detecting the human language includes at least one of natural language processing and speech recognition. In one implementation, training the application using machine learning includes at least one of applying neural network, mathematical optimization, artificial intelligence, and exploratory data analysis using unsupervised learning. In one implementation, setting parameters includes setting a primary language to be detected. In one implementation, filtering each channel includes determining a number of channels in the audio file. In one implementation, generating the list of timecodes includes tagging start and end times of the detected human language. In one implementation, filtering each channel includes detecting a primary language in all channels of the audio file. In one implementation, the method further includes determining whether the detected human language is to be removed. In one implementation, the method further includes removing the detected human language from the audio file using the list of timecodes, when it is determined to remove the detected human language. In one implementation, filtering each channel includes detecting a primary language in all channels of the audio file. In one implementation, generating the list of timecodes includes tagging start and end times of the detected human language; and removing the detected primary language includes removing the detected primary language starting at the start time and ending at the end time. In one implementation, the method further includes repeating removing the detected primary language until the end of timecodes in the list of timecodes; and delivering an output in the audio deliverable. In one implementation, removing the detected primary language includes removing only the human language but not removing non-language sounds, including grunts and lip smacks. In one implementation, the audio deliverable includes metadata with the list of timecodes incorporated into it. In one implementation, the metadata includes the detected human language and a title of the movie to which the audio file belongs.

In another particular implementation, a system for automatically detecting, tagging, and removing a human language stored in an audio file is disclosed. The system includes: an application for detecting the human language; a machine learning logic to train the application, wherein the trained application receives and loads each channel of the audio file, which is an audio deliverable for motion picture and television; and a filter to set parameters and filter each channel of the audio file to detect and tag the human language, and to generate a list of timecodes and the corresponding human language detected.

In one implementation, the filter sets a primary language to be detected. In one implementation, the filter filters each channel to determine a number of channels in the audio file. In one implementation, the application is built as a plugin that resides on a track of a Digital Audio Workstation.

In another particular implementation, a non-transitory computer-readable storage medium storing a computer program to automatically detect, tag, and remove a human language stored in an audio file is disclosed. The computer program includes executable instructions that cause a computer to: train an application for detecting the human language using machine learning; load each channel of the audio file into the trained application, wherein the audio file is an audio deliverable for motion picture and television; set parameters and filter each channel of the audio file to detect and tag the human language; and generate a list of timecodes and the corresponding human language detected.

In one implementation, the computer program further includes executable instructions that cause a computer to: determine whether the detected human language is to be removed; and remove the detected human language from the audio file using the list of timecodes, when it is determined to remove the detected human language.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for at least one of automatically detecting, tagging, and removing a human language stored in an audio file, the method comprising:
training an application for detecting the human language using machine learning;
loading each channel of the audio file into the trained application,
wherein the audio file is an audio deliverable for motion picture and television;
setting parameters and filtering each channel of the audio file to detect and tag the human language; and
generating a list of timecodes and the corresponding human language detected.

2. The method of claim 1, wherein the application for detecting the human language includes at least one of natural language processing and speech recognition.

3. The method of claim 1, wherein training the application using machine learning includes
at least one of applying neural network, mathematical optimization, artificial intelligence, and exploratory data analysis using unsupervised learning.

4. The method of claim 1, wherein setting parameters includes setting a primary language to be detected.

5. The method of claim 1, wherein filtering each channel includes determining a number of channels in the audio file.

6. The method of claim 1, wherein generating the list of timecodes includes
tagging start and end times of the detected human language.

7. The method of claim 1, wherein filtering each channel includes detecting a primary language in all channels of the audio file.

8. The method of claim 1, further comprising
determining whether the detected human language is to be removed.

9. The method of claim 8, further comprising
removing the detected human language from the audio file using the list of timecodes, when it is determined to remove the detected human language.

10. The method of claim 8, wherein filtering each channel includes detecting a primary language in all channels of the audio file.

11. The method of claim 10, wherein generating the list of timecodes includes tagging start and end times of the detected human language; and
wherein removing the detected primary language includes removing the detected primary language starting at the start time and ending at the end time.

12. The method of claim 11, wherein removing the detected primary language includes removing only the human language but not removing non-language sounds, including grunts and lip smacks.

13. The method of claim 1, wherein the audio deliverable includes metadata with the list of timecodes incorporated into it.

14. The method of claim 13, wherein the metadata includes the detected human language and a title of the movie to which the audio file belongs.

15. A system for at least one of automatically detecting, tagging, and removing a human language stored in an audio file, the system comprising:
an application for detecting the human language;
a machine learning logic to train the application,
wherein the trained application receives and loads each channel of the audio file, which is an audio deliverable for motion picture and television; and
a filter to set parameters and filter each channel of the audio file to detect and tag the human language, and to generate a list of timecodes and the corresponding human language detected.

16. The system of claim 15, wherein the filter sets a primary language to be detected.

17. The system of claim 15, wherein the filter filters each channel to determine a number of channels in the audio file.

18. The system of claim 15, wherein the application is built as a plugin that resides on a track of a Digital Audio Workstation.

19. A non-transitory computer-readable storage medium storing a computer program to automatically detect, tag, and remove a human language stored in an audio file, the computer program comprising executable instructions that cause a computer to:
train an application for detecting the human language using machine learning;
load each channel of the audio file into the trained application,
wherein the audio file is an audio deliverable for motion picture and television;
set parameters and filter each channel of the audio file to detect and tag the human language; and
generate a list of timecodes and the corresponding human language detected.

20. The non-transitory computer-readable storage medium of claim 19, further comprising executable instructions that cause a computer to:
determine whether the detected human language is to be removed; and
remove the detected human language from the audio file using the list of timecodes, when it is determined to remove the detected human language.
